(19) United States
(12) Patent Application Publication
(10) Pub. No.: US 2014/0226775 A1
(43) Pub. Date: Aug. 14, 2014

(54) Liquid Lithium Cooled Fission Reactor for Producing Radioactive Materials

(71) Applicant: Alexander Devolpi, Oceanside, CA (US)

(72) Inventor: Alexander Devolpi, Oceanside, CA (US)

(73) Assignee: NUCLEAR APPLICATIONS, LLC

(21) Appl. No.: 13/815,218

(22) Filed: Feb. 11, 2013

(51) Int. Cl. G21G 1/00

(52) U.S. Cl. CPC G21G 1/001
USPC 376/189

(57) ABSTRACT

A liquid lithium-cooled fission reactor optimized for producing radioactive materials. The reactor is designed to enhance the availability of rare radioactive materials that have significant value for national defense, industrial research, and medical care. This invention has tangible design attributes that can be tailored to create one or more scarce and valuable radioactive materials. In particular, the reactor design is optimized for low-cost production of large quantities of radioactive tritium needed in national-defense and fusion-breeder programs. There are four core designs applied to this invention, all of which produce tritium and surplus heat that can generate byproduct electricity, thereby reducing the cost of radioactive-material production. Three of the embodiments furnish radioactive fission products, such as molybdenum-99, that can be extracted with high efficiency and rapid processing, thus fulfilling a critical supply and price shortfall in radioisotopes used for medical diagnosis and treatment.

### CROSS REFERENCE TO RELATED APPLICATIONS

This application claims the benefit of Provisional Application No. 61/633,801 filed Feb. 16, 2012.

### FIELD OF THE INVENTION

The present invention relates to nuclear reactor systems and in particular to nuclear reactor systems designed for the production of valuable radioactive fission and activation products.

### BACKGROUND OF THE INVENTION

### Radioactive Material Production in Nuclear Reactors

A variety of specific radioactive materials (also called radioisotopes or radionuclides) are created by neutron irradiation or through other neutron interactions in nuclear reactors or particle accelerators.

Tritium (symbol H-3 or T), a radioactive isotope of hydrogen, is normally produced in nuclear reactors by neutron induced activation of lithium-6 (Li-6). This exothermic conversion process occurs with neutrons of any energy, but preferably thermalized, low-energy neutrons.

Thermalization of neutrons refers to a process by which neutrons produced by fission in a nuclear reactor are released with characteristic energies in the million-electron-volt (MeV) range, but are slowed-down (thermalized) by having been scattered and having lost energy in the process, mostly by interactions with nearby intervening substances. That process continues until the neutrons are either absorbed or, otherwise, migrate around or out of the nuclear reactor, usually as “thermal” neutrons that have a characteristic equilibrium-spectrum energy of about 0.025 eV.

Nuclear reactors are complex managed systems containing sufficient fissionable and other selected materials that allow the initiation, operation, and control of a sustained nuclear-fission reaction. A “critical” nuclear mass of fissile and other materials is needed in order to reach and maintain a self-sustaining neutron chain reaction.

Most nuclear reactors are considered “thermal” neutron-energy-spectrum reactors; others have operated as “fast” neutron-energy-spectrum reactors, using primarily unscattered high-energy neutrons to sustain the fission-rendered chain reaction; and other reactors have operated with an “intermediate” spectrum of neutrons that interact primarily at energies largely between the original fission energies and the ultimate thermal-reactor energies. The primary material and functional components of nuclear reactors that affect the average energy at which fission takes place are the fuel, the coolant, the neutron moderator and/or reflector, the containment structure, the radiation shielding, and the means and instrumentation to monitor and control the reactor.

In the course of operation, nuclear reactors transform materials that create radioisotopes and additional neutrons which multiply the desired neutronic effects by reaching the “critical” stage in which the fission reactions and neutron production are at a selected level of equilibrium.

One unavoidable but beneficial outcome of the fission process in nuclear fuels is the creation of characteristic radioisotopes called fission products. In addition, radioisotopes are produced in other components that comprise the reactor, especially those components involved in fuel, structure, and coolant.

Radioisotope-production scenarios currently faced internationally depend upon commercial, medical, military, political, perceptional and other factors. One of the major strategic considerations that will drive U.S. national-security radioisotope-stockpile requirements will be actual progress in nuclear-weapons arsenal reductions.

Nuclear reactors at the U.S. Savannah River complex produce three materials of military interest: Pu-239, tritium, and Pu-238. The Pu-238, used for radioactive thermoelectric generators, is produced sometimes in place of Pu-239 and tritium. Some production scenarios, therefore, affect the priorities and relative requirements for these three materials, and the scenarios are outlined below. The U.S. government investment in production of tritium is classified information, but might be in the billions of dollars.

### Radioisotope Production Requirements

Several radioisotope consumption and availability scenarios are drivers for current production requirements. During the Cold War, large nuclear arsenals required substantial production of tritium (and deuterium) for nuclear warheads. A routine procedure was and remains to be the removal and recovery of surplus tritium and deuterium from nuclear weapons, and to put the gases in indefinite storage.

However, other rare radioistopes are usually consumed or otherwise are non-recoverable when used in their planned applications. In addition, worldwide research and development of fusion-breeder reactors is partly dependent on the future availability of tritium.

As international nuclear-arms control progresses, with or without treaties and formal agreements, future special-material production defense-program requisites could swing towards away from Pu-239 and towards tritium and Pu-238. There is a considerable inventory of tritium in deployed and stockpiled weapons and tritium-reserve stockpiles of the U.S. national-defense program. However, because of its 12.3-y half-life, tritium stockpiles in defense programs would eventually need replacement unless nuclear weapons were entirely eliminated from arsenals. In effect, without production, the current inventory of tritium, whether in weapons or otherwise stored, would be diminishing at the rate of about 5.5% per year.

In addition, non-defense-program applications and requirements are increasing for tritium and Pu-238. For example, nuclear-fusion breeder development and deployment will require large quantities of tritium for startup.

### Tritium Requirements

Tritium's primary function has been to boost the yield of both fission and thermonuclear weapons. It is produced mostly in fission reactors by neutron capture in lithium, and also in small quantities by particle accelerators that bombard lithium or lithium target-compounds with high energy neutrons.

Because tritium decays naturally with its 12.3 years half-life, nuclear-weapon reservoirs must be replenished over time. Applicant has estimated that the United States has produced about 225 kilograms of tritium since 1955. In 50 years, this would have been reduced by a factor of about four, to 55 kg, exclusive of new production.

Because U.S. nuclear weapons fall strictly under government control, the responsible organization is primarily the National Nuclear Security Administration, which is a separate agency within the Department of Energy. Both agencies share responsibility and costs for tritium production.

Tritium also has an important, though comparatively minor, role in medical and industrial research and applications. At one time, it was used to illuminate watch dials. A portion of the tritium produced in the United States is used to make “Exit” signs, some watch dials, and instrument dials that do not require a power supply in ships and aircraft. Tritium is also used in medical and biological research for tracer studies. As mentioned, it may be required for the production of electricity by fusion reactors, which are currently in the experimental stage.

### Medical and Industrial Radioisotopes

Over 10,000 hospitals worldwide utilize radioisotopes in medicine, with 90% of the procedures being for medical diagnosis. The most common diagnostic radioisotope is technetium-99, with some 30 million procedures per year, accounting for 80% of all nuclear medicine procedures worldwide. The use of radiopharmaceuticals in diagnosis is growing at over 10% per year. Technetium-99 has a radioactive half-life of six hours, which is long enough to examine metabolic processes, yet short enough to minimize the radiation dose to the patient.

Technetium-99m (short-lived isomer) is derived (“generated”) from the fission product, molybdenum-99 (Mo-99), with a half-life of 66 hours. Technetium generators are containers designed to transfer decaying Mo-99 to hospitals from the nuclear reactor where it is created. Molybdenum-99 progressively decays to technetium-99 in the radioisotope generator. After two weeks or less, the generator is usually returned to the reactor to be recharged with fresh Mo-99. A similar generator system is used to produce rubidium-82 from strontium-82, which has a half-life of 25 days.

The technetium-99 decay product of Mo-99 is employed in about two-thirds of all diagnostic medical-isotope procedures in the United States. The Mo-99 market is about $5 billion per year, according to some sources.

Almost all of these diagnostic radioisotopes are produced in nuclear reactors, mostly a byproduct of the nuclear fission process either in reactor fuel or in specific targets that absorb neutrons.

Although medical radiotherapy is less common than is diagnostic use of radioactive material, it is nevertheless widespread, important, and growing. Fission-products iodine-131 and the activation-product phosphorus-32 are among the radioistotopes used for therapy. Both strontium-89 and strontium-90 are fission products. Strontium-89 is a short lived beta emitter which has been used in treatment for bone tumors. Strontium-90 is commonly applied for industrial sources. Cesium-137 is often used in radiotherapy, such as for the treatment of cancer, in food irradiation, and in industrial gauges or sensors.

Iodine-131 is another important gamma-emitting radionuclide produced as a fission product. With a comparatively short half-life of 8 days, iodine-131 is of great importance in nuclear medicine, and in medical and biological research as a radioactive tracer. Lanthanum-140 is a decay product of barium-140, a common fission product. It is a potent gamma emitter.

Activation-product radionuclides, such as cobalt-60 or iridium-192, offer high radiation output for a given volume.

### Commercial Supplies of Radioisotopes

Aside from an existing multiplicity of reactors dedicated to research and/or isotope production by irradiating specific targets, some new systems have been considered specifically for Mo-99 production.

Other medical isotopes such as iodine-131 and xenon-133 are by-products of the Mo-99 production process and will be sufficiently available wherever Mo-99 is available. These other medical isotopes are generally not being recovered for sale by all major Mo-99 producers because they can be more cheaply produced and purchased from other sources.

Because helium-3 is created when tritium decays, it is currently being accumulated in D-T gas reservoirs that would be used for nuclear weapons (where D represents the rare hydrogen isotope deuterium). Thus, as a matter of routine, and also in the course of scheduled nuclear-weapon dismantlement, the reservoirs would need to either be refilled with fresh D-T mixture or otherwise emptied into sealed containers to store the gas mixture. In either case, the accumulated helium-3 can be and is routinely separated from the mixture and saved for specific use as a neutron-detector filling or other designated special purpose.

If large-scale fusion reactors were to be built and were to use helium-3 as a fuel, they would need huge quantities of it each year, requiring substantial long-term expansion of facilities for tritium production and storage.

### Prior Art Molten-Salt-Cooled Reactors

While staying at low vapor pressure, molten-salt-cooled reactors function at higher temperatures than water-cooled reactors in order to achieve higher thermodynamic efficiency. Operation at low, near-atmospheric pressures reduces mechanical stress endured by the system, thus simplifying reactor design and improving safety. These reactors have a small effective reactor-core size, which represents an advantage over larger reactors in that there are has fewer extraneous internal materials to absorb neutrons competitively.

During the 1960s-70s, a molten-salt-cooled reactor experiment was constructed and operated at Oak Ridge National Laboratory; this reactor had piping, core vessel, and structural components made from Hastelloy-N, and its (external) neutron-moderating reflector was pyrolytic graphite. The fuel for this reactor was LiF—BeF2-ZrF4-UF4 (65-30-5-0.1 proportions). The graphite in the core provided neutron moderation, and its secondary coolant was “FLiBe” (2LiF—BeF2). It reached temperatures as high as 650° C. and operated intermittently for the equivalent of about 1.5 years of full-power operation. A result of this experimental-reactor research through 1976 was design of the Molten Salt Breeder Reactor (MSBR) which would use LiF—BeF2-ThF4-UF4 (72-16-12-0.4 proportions) as fuel, to be moderated by graphite, and have a peak operating temperature of 705° C. However, no large-scale molten-salt nuclear power plant has been built.

Now being developed in Japan is the FUJI molten-salt-fueled, thorium-fuel-cycle. thermal-breeder reactor that uses technology similar to the Oak Ridge National Laboratory's MSR experiment. As a breeder reactor, it would convert thorium into the nuclear fuel uranium-233. To achieve reasonable neutron economy, the chosen FUJI single-salt design results in significantly larger feasible size than a reactor in which the blanket is separated from core. As a thermal-spectrum reactor, the FUJI neutron regulation is inherently safe. Like all molten salt reactors, its core is chemically inert and under low pressure, reducing the likelihood of explosions and toxic releases.

### Prior Art Molten-Salt-Converter Reactors

Another type of reactor system under consideration are molten-salt-converter reactors, in which some or all of the nuclear fuel is in a liquid salt form, and the liquid salt is used as the heat-transfer medium. The previously described molten-salt liquid-fueled reactors are quite different from molten-salt solid-fuel reactors.

The molten-salt converter reactor retains the safety and cost advantages of a low-pressure, water or high-temperature coolant (also shared by liquid-metal-cooled reactors). Notably, there is no steam in the core to cause an explosion, and the steel pressure vessel is not as thick nor as expensive. Since it can operate at high temperatures, conversion of the heat to electricity can be accomplished with an efficient, lightweight Brayton-cycle gas turbine.

Techniques for preparing and handling molten salt had first been developed for industrial common-salt purification in order to eliminate oxides, sulfur, and metal impurities. Oxides produced during reactor operation can result in the deposition of solid particles inside reactor components and tubing. Sulfur had to be removed from molten salts because of its corrosive attack on nickel-base alloys at operational temperature. Structural-metal impurities such as chromium, nickel, and iron have to be removed for control of corrosion in the internal piping, vessels, and heat exchangers.

Liquid salts offer two potential advantages: smaller equipment size, because of the higher volumetric heat capacity of the salts, and the absence of chemical exothermal reactions between the reactor, intermediate loop and power-cycle coolants.

### Prior Art Aqueous-Solution Reactors

An alternative means for increased production of fission products could be based on aqueous homogeneous reactor technology using low-enriched uranium in small (100-200 kW) units where the fuel is mixed with the moderator and the U-235 acts as both the fuel and the irradiation target. The reactor is created out of low-enriched uranium dissolved in aqueous acid solution and brought to criticality in a vessel that might contain about 200 liters of mixed fuel and moderating solution.

As fission proceeds, the solution is circulated through an extraction facility to remove the fission products and then back into the reactor vessel, which is operated at low temperature and pressure.

In 1992, a method of “target-less” production of the fission product Mo-99 was introduced using an aqueous homogeneous reactor fueled with uranyl nitrate. The design anticipated that the water-based uranium salt could be made with low-enriched uranium. The circulating fluid, also acting as a reactor coolant, was a mixture of uranium fuel dissolved in water. As fission proceeds the solution is circulated through an extraction facility to remove the fission products containing Mo-99 and then back into the reactor vessel, which is at low temperature and pressure.

Approximately 30 aqueous homogeneous solution reactors have been built and operated world-wide over many years since the beginning of modern nuclear programs in the 1940s and 1950s. The use of solution reactors for the production of medical isotopes is potentially advantageous because of their low cost, small critical mass, inherent passive safety, and simplified fuel handling, processing, and purification characteristics.

The principal advantages of aqueous fuel systems include: flexibility with respect to reactor-parameter variation, fuel selection, and geometry; inherent nuclear safety characteristics; efficient neutron utilization for isotope production; elimination of inefficient target irradiation; less uranium waste generated per curie of fission product produced, overall simpler waste management; ability to process other isotopes more efficiently using off-gas extraction; and lower capital cost and potential lower operating costs.

What is needed is a small or medium scale nuclear plant for real-time production of valuable radioactive fission and activation products, as well as the production of process heat and electrical power.

### SUMMARY OF THE INVENTION

The present invention provides a small- or medium-scale nuclear plant for real-time production of valuable radioactive fission and activation products, as well as the production of process heat and electrical power.

Elements of the invention include a lithium-containing primary coolant that also contains fissile or fertile material arranged so that the primary coolant will accumulate large quantities of tritium and other valuable radioactive products. The invention also includes a processing loop through which a small portion of the primary coolant is directed through a chemical-processing facility for continuous removable of selected valuable radioactive products. In preferred embodiments the primary coolant includes a molten salt that contains lithium and the fissile or fertile material which preferably consists of uranium, plutonium or thorium.

In a particular preferred embodiment, the plant is a 300 MWth (100 MWe) facility having a primary coolant loop that contains a molten salt as well as the fissile or fertile material. This particular embodiment also includes a secondary molten-salt coolant loop in which features are included to minimize radioactive products. The secondary loop in this preferred embodiment provides high-temperature heat to efficiently power a steam generator plant to produce up to at least 100 MWe of electrical power.

This invention is designed to enhance the production of rare radioactive materials that have significant value for national defense, research, medical care, and electricity production.

Products of the plant include the electrical power, tritium, technetium-99, and other valuable radioactive products.

Some radioactive materials—such as tritium (designated symbolically as T or H-3); helium-3 (He3 or He-3); plutonium-238 (Pu-238); and various radioisotopes derived from nuclear-fission byproducts—are scarce in nature and difficult to produce, yet have important roles—current and future—in advanced national-security applications, ongoing scientific and industrial research, modem medical diagnosis and treatment, and future commercial energy production.

A lithium-liquid-cooled intermediate-neutron or fast-neutron energy-spectrum fission reactor (liquid-lithium-cooled reactor—LLCR) has tangible attributes that can be tailored to enhance the production of one or more of these scarce radioactive materials. Liquid lithium in this invention has a multipurpose role: as a neutronic moderator, as a circulating reactor coolant, and as a medium for transporting radioactive substances to various material-extraction devices.

Compared with other nuclear reactors applied or engineered for radioactive-material production, the proposed LLCR disclosed in this invention would provide higher effective production rates (yields) specifically for tritium and for selected fission-product radioisotopes. Also, the LLCR of this invention would have greater production flexibility to meet uncertain and potentially changing national and international requirements in a multi-decade planning horizon.

Another attribute intended for this invention is a designed capability such that the specialized lithium-cooled nuclear reactor would be functionally licensable and economically viable, while meeting prioritized goals of national importance.

### BRIEF DESCRIPTION OF THE DRAWINGS

FIG. 1 is a drawing showing important features of a preferred embodiment of the present invention.

FIG. 2 is a cross section drawing showing the top view of the structure of a potential core design for the above preferred embodiment.

FIG. 3 is a cross section side view drawing of the structure of the core design shown in FIG. 2.

FIG. 4 is a cross section drawing showing a top view of the structure of a second core design for the above preferred embodiment.

FIG. 5 is a cross section drawing showing a side view of the core design shown in FIG. 4.

### DETAILED DESCRIPTION OF PREFERRED EMBODIMENTS

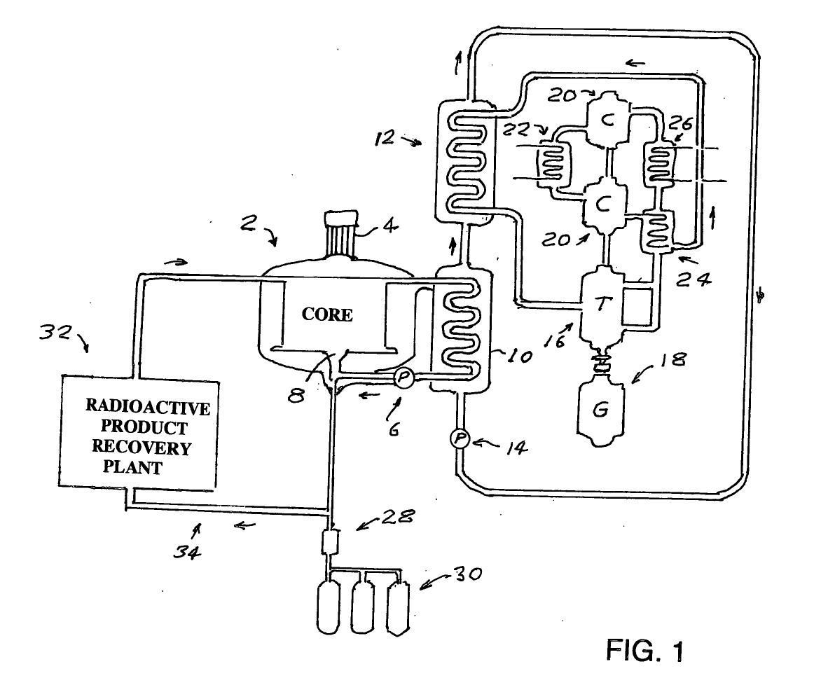

FIG. 1 is a drawing showing important features of a proposed nuclear large scale nuclear plant for the production of electric power and in addition real time production of large quantities of valuable radioactive fission and activation products. The main features of the are the reactor 2, control rods 4 primary coolant pump 6, molten salt coolant 8, primary heat exchanger 10, secondary heat exchanger 12 secondary coolant pump 14, turbine 16, electric power generator 18, two compressors 20, heat sink 22, recuperator 24 and precooler 26. This preferred embodiment includes a fail-safe system that includes a freeze plug 28 below the reactor that is cooled by a small electric fan. If there is a power failure the frozen salt in the freeze plug will melt and the hot salt will drain into a sub-critical passively-cooled storage facility 30. Also shown in FIG. 1 is a radioactive product recovery plant 32 and recovery loop 34 through which a small portion of the molten salt coolant is continuously directed for the removal of tritium and other valuable products of the fission process. The product recovery plant is located at significant distance from the reactor and can be easily isolated from the reactor by valves not shown.

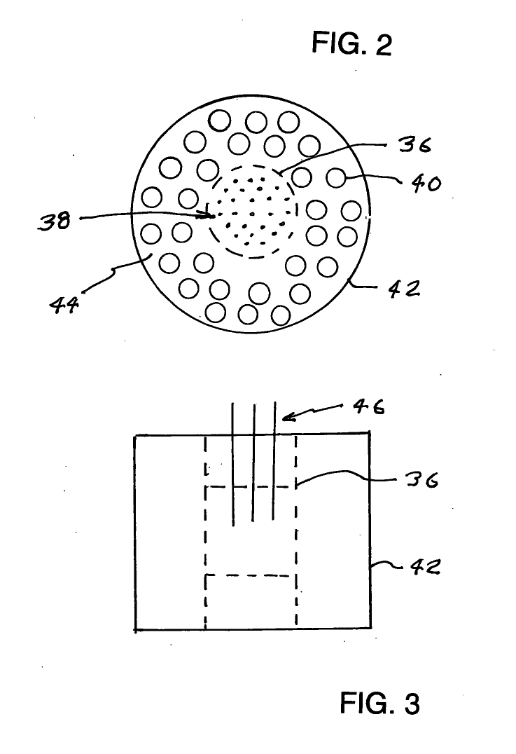

FIGS. 2 and 3 show a core design that utilizes traditional clad solid-fuel assemblies cooled by the lithium-containing primary coolant and includes a neutron reflector zone. The outer periphery of the reactor core zone is shown at 36. Fuel elements are shown at 38. These elements are preferably porous so as to permit the release of gaseous fission products into the liquid lithium coolant. The upper and lower portions of the fuel assemblies preferably comprise a moderator material such as graphite of beryllium. These upper and lower sections are preferably fully clad to minimize any corrosive action by the coolant. Moderator elements are shown at 40 which are comprised of a neutron moderator such as graphite or beryllium oxide. The pressure containment vessel is shown at 42 and is comprised preferably of a corrosion-resistant steel. The liquid lithium coolant is shown at 44 and control rods are shown at 46

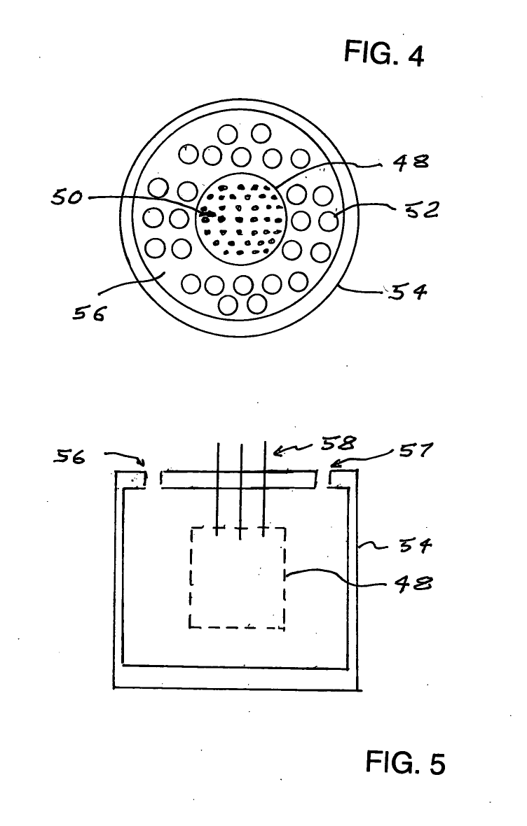

FIGS. 4 and 5 show a core design where the fissile fuel is contained in the circulating coolant. The core and the rest of the coolant loop are designed so that the only region in the coolant loop where nuclear criticality is achieved is in the core portion of the coolant loop. The outer periphery of the core is shown at 48. Moderator elements are shown at 50. Additional moderator elements are shown at 52 and they are designed to moderate and reflect neutrons back into the core region. The reactor pressure vessel is shown at 54. Inlet and outlet ports are shown at 56 and 57. Control rods are shown at 58.

### Tritium Production

In the present invention the design of the lithium-cooled reactor is optimized to produce tritium in the coolant primarily by the exothermic nuclear reaction designated:

Li-6+n=He-4+H-3=α+T,

where symbol α represents the alpha-particle otherwise denoted He-4.

High-energy neutrons in the reactor can also produce tritium from lithium-7 in an endothermic reaction.

Li-7+n=He-4+H-3+n=α+T+n

Natural lithium contains about 7.4% Li-6, the balance being Li-7.

### Reactor Design Considerations for Radioactive-Material Production

A measure of neutron-interaction probability is normally specified by the artificial unit of “barns,” abbreviated b. For “slow” (thermalized) neutrons, the Li-6 cross-section for conversion to tritium is 950 b; and for Li-7 conversion to tritium, it is about 0.04 b. The overall tritium-production slow-neutron cross-section for natural lithium is about 65 b. As a result of these comparatively large cross-section values, it is not necessary for the purposes of this invention to replace natural lithium with enriched lithium as the moderator/coolant in this reactor configuration.

The higher the lithium content in the reactor coolant, the higher the LLCR production rate of tritium, which directs this invention preferentially to liquid lithium metal as the LLCR coolant. Lithium has a melting point of 179° C.; so it is not difficult to attain and maintain liquidity. However, these advantages of lithium metal should be compared to the advantages associated with the use of lithium salt. Preferred embodiments of the present invention include both lithium salt and liquid metal solutions.

Presented below for this invention are answers to some, but not all feasibility questions that might arise. However, the provisional answers are sufficient for the invention. Calculations demonstrate that the underlying physics, safety, and engineering analysis are valid, based on appropriate parametric approximations. Moreover, a superficial survey of market requirements has been made so as to optimize production based on estimates of future required radioisotope production.

There are several basic reasons for expecting LLCR capital costs to be lower than those for the more advanced liquid-metal fast-breeder reactors (LMFBR), which also use a molten salt (usually sodium) as coolant.

These reasons which benefit the LLCR are:

1. The fuel handling system will be much simpler.
2. The molten salts have a much higher heat capacity per unit volume than sodium, so that the physical size of pumps and piping will be smaller.
3. There is no threat of a “core disruptive accident” with the LLCR, so that safety-related equipment can be simpler.
4. The molten salts have a much lower thermal conductivity than sodium, so that sudden coolant temperature changes will provide less thermal shock to system components.
5. The coolant is more compatible with water than is sodium, so that there should be fewer problems in the design and maintenance of steam generators.

Molten-salt reactors, as differentiated from other types of reactors, have important and inherent distinguishing features that enhance passive safety, such as negative feedback coefficients, smaller fissile inventory, easy in-service inspection, and simplified hazard-reduced fuel cycle. In addition, molten-salt reactors can be constructed with fissile materials of low enrichment, which satisfies non-proliferation concerns and Congressional mandates.

### Solution Reactors for Medical Isotope Production

Because of the looming shortfall in medical radioisotopes, solution reactors specializing in radioactive-materials production have been under development in several countries.

Compared with solid-target irradiation in a dedicated production reactor, a homogeneous reactor system for radioisotope production has advantages that include the following:

1. No need to fabricate and transport targets to the reactor for radioisotope production. (This reduces the net effective cost of radioisotope production.)
2. Full utilization of the produced fission product Mo-99. (That's because, in the target-irradiation process, fission products [including Mo-99] in the reactor core are wasted; the core-fission product inventory of Mo-99 remains in the solid reactor fuel. Typically 100 times as much Mo-99 is produced in the core as in the target.)
4. Uranium consumption per quantity of product is typically 1/100th of that required for the target method.
5. Fission-product extraction processing is simplified with no uranium dissolution required in the homogeneous reactor.

Of course, certain quality-control factors need to be validated and maintained for a homogenous-reactor radioisotope-production system. For example, it must be determined that any extraneous alpha-radiation activity in the Mo-99 product derived from a uranium solution is within specifications. It must also be demonstrated that the separated Mo-99 will meet specifications for residual uranium content. It may be possible that existing sorption and purification techniques will suffice. (Note that these requirements also apply to uranium-target methods of Mo-99 production.)

Because of their comparatively short lifetimes, a premium is placed on extracting short-lived fission products from the reactor in as brief a time as possible. This goal is also satisfied with the liquid-metal coolant of this invention, where it is possible to extract not only tritium but also fission products immediately and continuously after production in the LLCR nuclear fuel.

Research has also been directed at sorbents that can assist efficient extraction of special isotopes from the irradiated fuel.

Since no operating license applications involving solution reactor facilities for isotope production have been submitted for approval, world-wide nuclear regulatory bodies have not developed regulations that address solution reactors for commercial isotope production. While two solution reactors were licensed in the United States by the Atomic Energy Commission, these reactors were not commercial isotope-production facilities. Current U.S. Nuclear Regulatory Commission rulings address power reactors, commercial reactors, and research reactors. As a result, the LLCR of this invention is likely to be a government-sponsored and funded project and probably located on a government reservation.

### Specific Preferred Embodiments

The LLCR of this invention has considerable flexibility in its intended role and its corresponding design. Of these four basic embodiments, the one that would be preferred would depend more on national-security, economic, medical-supply, and other considerations more than it would depend on technical feasibility.

### Design and Operation Flexibility

The lithium-based coolant volume and circulation are adjustable so that lithium production rates can be optimized or so that fission products can be extracted on-line from the coolant (without reactor shutdown).

Heat transferred to or produced in the coolant mixture can be recovered for the purpose of use as process heat or steam generation, thus helping to offset the cost of construction and operation.

The LLCR can also be designed to produce more than one type of radioactive material, as specified in design requirements.

By optimizing the coolant flow rate and other parameters, the timely extraction of tritium and other radioactive materials can be optimized by minimizing delay between time of production and time of extraction and availability.

Rough estimates of tritium production under this invention are provided below. The tritium is created within the coolant.

The estimated production rate of tritium in a lithium-rich coolant embodied in this invention should be significantly higher than the batch process in which light-water-reactor control-rod channels are replaced with special elements containing lithium in solid form. The later is the means now used in the United States for tritium production by irradiation in commercial nuclear-power reactors operated (at comparatively higher neutron flux) by the Tennessee Valley Authority (TVA). At the TVA facility, burnable neutron-absorption rods that contain solid lithium are irradiated in commercial light-water reactors under long-term government contract. The Tritium Extraction Facility at Savannah River has the capability to collect tritium from the neutron-absorption rods.

When tritium radioactively decays, it becomes helium-3, which is a rare and precious commodity. One reason for the increasing demand for helium-3 is its use in neutron-detection equipment that is being installed all over the world to detect nuclear materials. Helium-3 can be recovered, purified, and bottled as a byproduct of tritium. At present the Savannah River site is the sole recovery site for helium-3 gas in the United States.

Tritium and helium-3 can be separated from the LLCR coolant by passage through a hydride bed. Mass spectrometers can be used to verify tritium production.

### Technical Aspects of the Invention

For the liquid-fuel embodiment of the LLCR invention, nuclear fuel is entrained in the liquid-metal coolant, thus—at sufficient density and mass—forming a nuclear-fission reactor which circulates the coolant-fuel mixture through the reactor containment vessel and through piping that continuously carries a sub-critical portion of the coolant-fuel mixture out of the reactor containment and through extraction devices external to the containment vessel. These extraction devices are used to remove tritium and fission products from the circulating fluid and allow the radioactively-depleted fluid to return to the reactor. In addition, the fissile content of the circulating fluid needs to be augmented with additional fissile material as needed to maintain reactor criticality and radioisotope production.

In this current LLCR invention, continuous on-line processing of the molten salt reduces the inventory of fission products, controls corrosion, and improves neutron economy by removing fission products, such as xenon, that have high neutron absorption cross-section. These particular benefits are ancillary to the need for deliberate removal of fission products and tritium to meet the objectives of this invention. However, it is important to note that the continuous removal of fission products also reduces the initial fuel loading and operational fuel-makeup requirements.

On the other hand, on-line processing introduces a small risk of possible fuel-processing accidents which must be countered by design, construction, and management practices that reduce such risk to minimal and harmless levels.

The term “reprocessing” often refers to the deliberate chemical separation of fissionable uranium and plutonium from spent nuclear fuel. That procedure involving deliberate materials separation is avoided because of nuclear-weapons proliferation concerns. In this LLCR invention, proliferation-prone fissile and fertile heavy-metal components would not be separated from each other in the fissile-supply feed returned to the reactor. However, the net accumulation of fissile material, as well as the net amount of fissile poisons, would have to be properly managed in order to maintain sufficiently critical nuclear operation for the purpose of producing radioisotopes.

Molten salts trap fission products chemically, and react slowly in air, or not at all. Also, the molten-fuel salt does not burn in contact with air or water. The core and primary cooling loop of a LLCR would be operated near atmospheric pressure, and would have no water-produced steam; as a result, a pressure explosion is highly improbable. Even in the case of accidental liquid-metal leakage, most radioactive fission products would remain in the liquid-metal salt instead of dispersing into the atmosphere.

A molten core reactor (with the nuclear fuel contained within a molten salt circulating coolant) cannot have a solid-core meltdown or a more critical geometry; so the worst conceivable accident would be a leak of the thermodynamically and radioactively hot coolant. In this case, that fuel-salt mixture can be drained into diverse passively cooled storage bins, thus containing and managing any accident.

This type of molten-salt reactor is comparatively inexpensive. Since the core and primary coolant loop are operated at low pressure, it can be constructed of comparatively thin, relatively inexpensive vessels and weldments. The container would be far less expensive than the massive pressure vessel required for a traditional light-water power reactor.

Temperatures of the LLCR designs are high enough to produce steam that can be used directly for plant heating or electricity generation. The surplus process heat could also be employed for hydrogen production or other chemical processes.

The LLCR in its molten-salt fissile-carrier version also has excellent neutron economy. It can be designed to operate with a harder (higher-energy) neutron spectrum than conventional light water reactors, thus allowing a wider range of stable nuclear fuel compositions.

As stated in the background section, molten-salt reactors as small as several megawatts have been constructed and operated. Although little additional development would be required to implement an LLCR, there would be a need to design, construct, and operate an on-site chemical plant to manage the liquid-core mixture and to remove/separate fission products and tritium.

To deal with LLCR design and operation that departs from standard light-water reactors, regulatory changes might be needed.

Internal corrosion is likely to very slow, over many decades of reactor operation, and thus could be continuously monitored and managed.

Among the most promising coolants that have been developed to date, 2LiF—BeF₂ (shorthand Flibe, for its F, Li, and Be constituents) has particular benefits. Its total neutron capture relative to graphite (per unit volume) is a ratio of about 8, and its neutron-moderating ratio (in the energy range of 0.1 to 10 eV) is about 60. Some key parameters of Flibe are a melting point of 459 □C, a boiling point of 1430 □C, a density of 1940 kg/cubic meter. Flibe has good specific heat, heat capacity, thermal conductivity, and kinematic viscosity properties. A mixture of LiF—BeF₂—ZrF₄ (in proportions 64.5-30.5-5) would be similar, but have a 10% smaller neutron moderating ratio.

Both lithium and beryllium are reasonably effective neutron moderators, and they form a eutectic salt mixture that has a lower melting point than each of the constituent salts. Beryllium also performs neutron doubling, thus improving neutron economy in the solution.

Each of these coolants notably has substantial desired components, in the form of lithium as the “target” substance for tritium production, beryllium as a fully encompassing neutron moderator to efficiently reduce the energy of fission-produced neutrons, and the other constituents to conduct heat, transport fission products, and retain the solution as a stable liquid while undergoing internal neutron reactions and corrosive fission and chemical activity.

### Technical Aspects of the Embodiments

Two solid-fuel embodiments of the LLCR invention are designated. The first uses the more traditional cladded fuel, and the second embodiment use a variation which would be largely uncladded in its central (vertical) fuel zone.

The cladded zones in both cases would consist of standard low-neutron-absorption materials, such as zircaloy.

For the uncladded (porous) solid fuel, the vertical extensions of fuel rod that are within the nuclear-fuel zone would only have as much structural material as needed to maintain operational rigidity under the coolant and radiation conditions experienced in the reactor. The fuel rod vertical extensions above and below the core nuclear-fuel zone could be clad with a strong material such as zircaloy or steel to maintain structural integrity. Usually these vertical extensions are filled with a neutron moderating material, such as graphite.

For the cladded solid fuel, the entire fuel rod would consist of the material chosen to protect the internal parts of the fuel rod from the coolant and radiation effects.

In the LLCR embodiment that has uncladded solid fuel, the fission products are free to mix with the lithium coolant and thus be transported with the coolant to the external devices used to extract radionuclide products as intended in this invention.

Even with porous solid fuel, some of the fission products might be unable to migrate into the coolant, or might be delayed in the process of migration out of the fuel, such that the fission-product radionuclide yield of this embodiment of the LLCR invention is not likely to be as productive for fission products as is the liquid-fuel embodiment.

### Fission Production Rates

For purposes of these estimates, all data for this invention will be normalized to an LLCR of 300 MWth, with an assumed thermal efficiency such that the corresponding electric-power output would be 100 MWe. This is a heat-production rating which falls within the range of small modular reactors that have been evaluated throughout the world because of anticipated optimized functional characteristics.

Fission gas is generated within the fuel during operation, and the amount is roughly proportional to the burnup.

A 1 MWth reactor burns up slightly more than 1 g/d of U-235. A 100 MWth solid-core reactor would burn up 100 g/d, thus having enough fuel to operate for 45 days in a single-stage refuel cycle if the burnable excess fissionable fuel were 4.5 kg. This refueling consideration would argue in favor of a liquid-fuel reactor, for which continuous on-line fuel replenishment (and radioisotope extraction) could take place.

### Molybdenum-99 Production Example

An important example of fission-product production is Mo-99, (which decays with a half-life of about 66 hours) to the commercially important radioisotope technetium-99m (Tc-99m, which decays with a half-life of about 6 hours). For the purposes of using Tc-99m, the longer Mo-99 half-life is the dominating factor in its supply.

Technetium-99m is extracted (“milked”) from a “moly cow” Mo-99 generator. The generator contains the Mo-99 isotope used as the “parent” to produce its decay product Tc-99m. Tc-99m is currently priced at $60/g.

All uranium-fueled nuclear reactors produce Mo-99, a result of fission in the fissile isotope U-235 contained in their reactor fuels. Aluminum fuel cladding for solid nuclear-fuel elements is comparatively easy to dissolve in order to extract fission products.

Assuming a 300 MWth reference reactor, about 0.300 g/day U-235 would thus be consumed at a rate of about 100 kg/yr fissile burnup, resulting in about 50 kg/yr of fission products. With a fission-product yield of 6%, Tc-99m would thus be produced at about 3 kg/yr. Its current price is $60/g, so 3 kg/yr would be worth about $180,000/yr. If we assume that the other radioisotopes produced are worth about the same on average, the fission-product radionuclide aggregation would be worth $2 M/yr from a 100 MWe reactor.

As stated in the Background Section, most of the world's production of Mo-99 has been carried out by irradiating high-enriched uranium targets in research and test reactors that are fueled with low-enriched uranium. With one exception, the United States is currently the world's primary supplier of highly enriched uranium for Mo-99 production. Approximately 40-50 kg of HEU (high enriched uranium) are used annually for medical isotope production.

The fission of uranium-235 (U-235) produces a spectrum of fission products including Mo-99, I-131, and Xe-133. These fission products are produced in the same relative proportions whether high-enriched or low-enriched uranium targets are used. All of these isotopes can be recovered when the targets are processed to obtain Mo-99.

The Mo-99 market is about $5 billion per year, according to nuclear-suppliers-group assessment in 2010. Sales and shipment are made to about 60 countries. Market analysis predicts supply shortages from 2016, not simply from reactors but also due to processing limitations. The U.S. Congress has called for all Mo-99 to be supplied by reactors running on low-enriched uranium, instead of high-enriched uranium.

### Extraction of Tritium

Different methods are available or have been evaluated for extracting tritium from lithium. Liquid lithium has a high solubility for tritium. One process used for dilute fractions of tritium involves a cold trap, followed by centrifuge separation. In a different process, tritium is extracted from lithium in a distillation column, which is a safer single-step process with high capacity.

The most well-developed process to recover tritium from lithium is the molten-salt-recovery process, which involves several steps. A cold-trap process has been also been demonstrated.

### Optimizing Tritium Production

The current U.S. inventory of tritium is variously published as being between 18 kg and 75 kg. On average, about 4 g are believed to be need for each nuclear warhead, implying 40 kg would be needed for a 10,000-warhead arsenal. At 5%/year decay rate, about 2 kg/yr are needed for replenishment of warheads.

In 1990, new tritium production cost was estimated to be in the range of $55 M/kg to $100 M/kg for up to 8 kg produced per calendar year, having increased from a reported cost of $29 M/kg.

The price for tritium supplied by Canada has been given as $30 M/kg. Future U.S. production cost has been estimated to be in the range of $100 M/kg to $200 M/kg.

For startup of a new dedicated tritium-production solid-fuel reactor with a 2 kg/yr capacity, costs have been estimated up to $200 M, thus requiring that tritium be sold at $100 M/kg.

### Energy Output

Assuming a 300 MWth reference reactor [100 MWe], which falls within the range of small modular reactors, the wholesale value of 100 MW of electricity at $50/MWe/day would be nearly $20 M/yr.

Depending on circumstances and commercial value, the steam-generation byproduct could be used directly in industrial processes.

Although the commercial value of steam is not a goal for the technical feasibility of this invention, it is important in terms of fiscal feasibility. Commercial electrical power reactors recover their financing, fueling, operating, and decommissioning costs of a period of several decades. The LLCR reactor should be able to produce steady, saleable electricity for the power grid.

### Tritium Production Rates

Of the nominal 2.5 neutrons/fission in the chain-reaction process, 1.0 neutron goes back into sustaining the critical reaction; in addition about 1.25 neutrons are lost to non-fission capture in control rods, moderator, structure, reflector, and leakage. That would leave about 0.25 neutrons per fission to be absorbed in the lithium coolant.

In comparing this LLCR invention with the current alternative process of solid-tritium irradiation in commercial reactors, some other benefits of the liquid-lithium concept can be noted. For designs of other reactors that involve solid lithium target rods, the rods after irradiation have to be off-loaded from the reactor, processed to remove tritium, and refabricated to return lithium to the irradiation cycle.

With a liquid-lithium coolant, the tritium will either remain entrained in the lithium or it will mix with an inert cover gas, such as argon. In either case, on-line systems will filter or distill the tritium, thereby reducing the cost of the production process and expediting the availability and quantity of tritium produced. On-line removal of the tritium might also be necessary in order to deal with its potential leakage through reactor seals.

For neutrons slowing down by scattering in liquid lithium, the neutrons will have little or no chance to become thermalized, but are more likely to become involved in the desired Li-6(n,t)He-4 reaction before reaching energies below 10⁴ eV in pure Li-6 and 10 eV in natural lithium. In essence, the reactor would operate with an epi-thermal spectrum. At comparatively small cost, a neutron reflector could be placed inside the outer periphery of the containment vessel, in order to moderate and reflect neutrons back into the coolant, thus increasing the net production rate.

The Li-7(n,2n) cross-section is relatively large; a neutron reaction with Li-7 produces a low-energy neutron as a replacement for the consumed fast neutron. This then increases the probability of neutron-induced tritium production in the Li-6. A moderating blanket of natural lithium would have to be at least 100 cm thick in order to have a good efficiency for converting neutrons to tritium. An alternative design may use neutron moderators and reflectors made of beryllium or carbon.

### Moderator Issues

A moderator blanket of graphite or beryllium oxide for the purpose of slowing down and returning fast neutrons before they escape from the reactor will improve the production of tritium. The neutron reaction cross-section in natural lithium follows a l/v law below the resonance at 255 keV, and its thermal neutron cross-section is more than thousand times larger than its fast-neutron cross-section.

If a moderator blanket were lined with lithium both inside and outside, few thermal neutrons would escape. The mean free path for absorption of thermal neutrons is 0.3 cm in natural lithium and 0.023 cm in pure Li-6.

With lithium used as the heat-carrying medium, it would be an advantage if the moderating blanked liner included flow channels for lithium in an otherwise solid moderator, and conversely, solid rods of moderator interspersed in the coolant zone surrounding the central core. The distance between channels should be of the same order of magnitude as the slowing down length of the moderator, and there should be more than one row of channels in the direction orthogonal to the blanket.

In terms of a radial profile, the following materials and neutronic functions would be installed radially from inside outward in a solid-fuel lithium-cooled and lithium-moderated LLCR: (1) a central uranium-fueled core zone with lithium coolant flowing around fuel rods; (2) a surrounding moderating zone of liquid lithium; (3) a deliberately spaced disposition of solid moderator rods; and (4) a zone of lithium reaching to the moderating solid liner inside the reactor containment. Said containment vessel would be surrounded by a biological shield, not necessarily in contact or close proximity to the reactor-containment vessel.

The advantage of a moderator blanket is not only the higher efficiency for the same blanket thickness, but also a lower lithium volume, all such benefits allowing a higher concentration of tritium after the same irradiation dose. This facilitates the recovery of tritium.

### Other Issues

Tritium's decay product, helium-3, has a very large cross-section for reacting with thermal neutrons, expelling a proton; hence it is rapidly converted back to tritium in nuclear reactors. If enough He-3 were produced during phases involving the separation and storage of tritium, the He-3 could be extracted and stored in separate sealed containers. In any event, He-3 is detrimental to the operation of the reactor, and would thus be removed as soon as possible.

Another aspect of the LLCR invention is its suitability for modularity that would allow a phased buildup of capability consistent with levelized multi-year funding. For example, a four-module system, each module at 300 MWth could allow an expansion of production capability at a rate dictated by requirements then prevailing.

With regard to impact on public and professional attitudes, the following thoughts are offered. As far as public perceptions are concerned, this reactor should not be considered to be in fast-reactor class. Nor is any provision made for deliberate “breeding” of fissile fuel such as Pu-239 or U-233, as would be the case for designs that enhance breeding in natural uranium or thorium. In any event, the LLCR will not introduce additional weapons-proliferation potential, and it would probably be limited to a single governmental site. The nuclear-reactor professional community could view a lithium-cooled reactor as being a progressive step in technology development.

Now for the comparative liabilities of the concept of a lithium-cooled LLCR: As a coolant, lithium has some advantages over sodium (It has a better heat capacity; also a higher boiling point]; however, it has some potential disadvantages. Lithium is more viscous and has a melting point twice as high as sodium. It's known to be at least as reactive as sodium, perhaps more so (for example, it reacts with nitrogen). In general, lithium seems to be much like sodium in its properties. There now is significant engineering data on lithium and its alloys as a result of the fusion program, but not much recent experience in the fission programs. In any event, the LLCR is designed to compensate for any perceived liabilities and to take advantage of its inherent advantages.

From the reactor-physics viewpoint, lithium in the coolant has a fast-neutron-spectrum cross-section similar to sodium. Both Li-6 and Li-7 will produce tritium in a fast spectrum; as a result, enrichment of the lithium might not be necessary. Lithium will cause larger energy losses than sodium upon elastic scattering, but the larger low-energy absorption cross-section will keep the spectrum hard. However—depending on the core, moderator, and circulation design—delayed neutrons will tend to be lost in terms of core reactivity because of the circulating coolant and the desire to extract fission products during on-line operation.

The total temperature coefficient of reactivity will be extremely important for control and safety reasons, and it will be affected significantly by the choice of moderator and its physical distribution in and around the core zone.

From the reactor safety viewpoint, its difficult to tell without detailed calculations and experiments how the coolant density and voiding effects will actually play out. They should be not too much different from sodium-cooled reactor, and fuel-coolant interactions seem to be as manageable as they have been for sodium-cooled reactors.

From the reactor-fuel integrity viewpoint, a shorter clad life might be experienced, but a LLCR production reactor is likely to incur a burnup only one-fourth or one-half that of a commercial reactor.

Regarding material-supply issues, there are two to be considered in particular: cost and safety. The lithium used for this reactor probably should not be highly enriched in its isotope Li-6. Besides the savings in enrichment costs, this could provide useful benefits in system safety.

From a reactor engineering viewpoint, lithium would have to be treated with the type of care given to sodium. Any special concerns about lithium are mitigated by the fact that we are here considering only one reactor site on a federal reservation. Design and engineering experience for lithium in the space and fusion programs has been extensive.

The primary limitations of the analysis presented in this specification are that the production projections are from extrapolations and “ball-park” estimates, public data sources were utilized, the open literature has not been thoroughly surveyed, and only “internal” discussions have been held regarding the concept. Some very specific data and computational needs have been identified. Relevant parameters used in the estimates above are listed and described below.

### Lithium and Tritium Parameters

While Li has one of the lowest melting points among all metals (179° C.), it has the highest boiling point (1317° C.) of the alkali metals. It has a very low density, of approximately 0.534 g/cm³. If nuclear fuel is mixed in with the coolant, then the fluid density will be accordingly higher.

Heat transfer coefficient is 1 cal/g-° C. for liquid lithium. Because of lithium's high specific-heat capacity, it is often used for heat-transfer applications.

Lithium reacts with water easily, but with noticeably less energy release than other alkali metals. In aqueous solution—which is not applicable in this invention—the reaction forms hydrogen gas and lithium hydroxide.

Multi-stage batch or on-line vapor extraction combined with helium bubbling can be used to remove gaseous fission product and some noble metals from the coolant. An off-line batch process separates transuranic actinides from fission products; these transuranic actinides can be salvaged as a product or discarded as waste.

At a natural abundance of 20 mg of lithium per kg of Earth's crust, lithium is the 25th most abundant element. Nickel and lead have about the same natural abundance.

Lithium fluoride, with its natural composition of lithium-6 (7.4%) and lithium-7 (92.6%) isotopes, forms the basic constituent of the fluoride salt mixture LiF—BeF2 that used in liquid-fluoride nuclear reactors. Lithium fluoride has exceptional chemical stability, and LiF—BeF2 mixtures have low melting points. Lithium is corrosive and requires special handling to avoid skin contact.

Here are some relevant neutron cross-sections found in the technical literature for neutron production of tritium (half-life=12.3 y):

Epithermal cross-sections: Li-6(n,T)=1 b (0.04 Mev); 3 b (0.25 Mev); 0.25 b (1.5 Mev).
Thermal cross-sections: Li-6(n,T)=950 b; Li(natural) (n, absorption)=65 b; Li-7 (n,T)=0.04 b.
Li cross-sections for Cf-252 spontaneous-fission neutron spectrum: Li-6(n,T)=0.45 b; Li-7(n,T)=0.02 b.

### Cost and Value

Inasmuch as financial costs are a major factor in ultimate invention feasibility and in specific design choices, some rough estimates are provided here. For each estimate, it is assumed that the embodiments of this invention would be in the form a 100 MWe small modular reactor of the indicated design.

In 2012 dollars, the aggregate production value for the LLCR-Liquid Fuel embodiment of this invention is estimated to be $72 M/yr, comprised of $50 M/yr for tritium production, $2 M/yr for fission-product production, and $20 M/yr for electric-power production all as explained below:

Based simply on monetary investment requirements, the construction cost of a 100 MWe nuclear-power plant is estimated to be roughly $200 M. The wholesale value of $20 M/yr is derived from 100 MWe being valued at $50/MWe/day. All three embodiments would produce heat which could be converted to electricity or to other processes that have equivalent value.

Tritium production would be the primary goal for the first embodiment, LLCR-cladded solid fuel. The value of tritium is based on expected production of 2.5 kg/yr, worth at least $20 M/kg, for a net value of $50 M/yr. This would be therefore the financial basis for comparing each embodiment with other small modular reactors that simply produce 100 MW of electricity with no saleable byproducts.

The three other LLCR embodiments provide an added capability for on-line extraction of fission products. In order to estimate their added value, the 6% fission-product yield of technetium produced at the rate of about 3 kg/yr, with current price of $60/g, has been extrapolated—with the further (conservative) assumption that the other radioisotopes produced are worth about the same on average—such that the fission-product radionuclide extracted collection would sell for an aggregate of about $2 M/yr.

However, in this estimate of extracted fission products, credit has not been taken for improved effective yield based on reduction of delays and losses because of improved efficiencies and delay reductions that should result from efficient and timely on-line extraction. Because of the rapid decay of some of the fission products, shortening the extraction-processing time by one half-life for any given radioisotope will result in a doubling of its production yield.

The resulting incremental cost of each additional embodiment, in going from cladded solid fuel to uncladded solid fuel, and then further to liquid fuel, will depend on the results of an integrated engineering-cost assessment, which itself will depend on a number of factors associated with regulatory approval and siting. For example, if, because of the national-security requirements in tritium production, a government reservation is chosen for the reactor site, shorter regulatory approval time frames and lower construction costs would probably be applicable.

In any event, no government subsidy would be required, and costs now experienced in the U.S. national tritium-production program would be alleviated, thus reducing the net investment cost of all three of these invention embodiments. Moreover, no credit has been applied for incidental production of He-3 and some valuable trans-uranium radioisotopes, partly because their incremental worth would be small compared to the featured radioactive-material products. Nor has any credit been applied for probable future demand and worth of tritium if fusion reactors are further developed or come into production.

Understandably, adoption (with minimal modification) of a previously researched and demonstrated technology, such as the Molten Salt Reactor Experiment at the Oak Ridge National Laboratory, will shorten construction time and reduce costs for many reasons. On the other hand, efforts to include other objectives—such as thorium breeding—in the first LLCR reactor design might cause delays and increased cost.

### U.S. Government Tritium Cost

It is difficult to sort out the appropriate levelized tritium-production costs to the U.S. government because relevant information has been only partially released or collected in a single data location.

In late-1990s, government estimates involved use of one planned reactor in Alabama, and the Department of Energy (DOE) would have had to pay for shipping the lithium-target rods from the reactor to the tritium-extraction facility at the Savannah River Site, operating that extraction facility, and manufacturing replacement target rods. According to information provided by DOE, those activities would cost an average of about $28 M/yr, beginning fiscal-year 2005. In addition, providing irradiation services would cost the Tennessee Valley Authority (TVA) reactor owner/operator an average of about $5 M/yr, which presumably would have been reimbursed by the U.S. government.

TVA would continue to own and run the reactors and sell the electricity generated. DOE would be responsible for constructing the tritium-extraction facility, manufacturing the target rods, shipping the rods from the nuclear reactors to the extraction facility at Savannah River, and extracting the tritium. The estimate assumed that DOE would compensate TVA for the actual cost of the irradiation services. Such an irradiation-services contract with TVA would have cost nearly $45 M/yr.

In 1998, DOE announced that other TVA commercial reactors would be the source for new tritium production. The Watts Bar Unit 1 and Sequoyah Unit 1 and Unit 2 reactors were selected for irradiation of DOE-supplied Tritium Producing Burnable Absorber Rods (TPBARs). The TPBARs were to be irradiated in the reactor and then transported to Savannah River, where tritium is extracted in the Tritium Extraction Facility. The tritium is then piped for further purification prior to loading into reservoirs for shipment to the Department of Defense, which carries out tritium refilling of deployed nuclear warheads.

In October 2003, the first TPBARs were inserted into TVA's Watts Bar Reactor for irradiation. The first shipment of irradiated TPBARs arrived at SRS in August 2005. Tritium was extracted from TPBARs in January 2007 and transferred via underground piping to the Tritium Loading Facility in February 2007. In effect, it took over four years to irradiate and process the first TPBARs. As many as 2500 TPBARs were originally planned, but less ordered, at a cost $1300/TPBAR.

The tritium-readiness program payment to TVA is estimated to be about $1.5 B for 35 yr, or about $43 M/yr.

Under a new plan in 2011, TVA was to increase irradiation of TPBARs from the current rate (there are 554 bars now being irradiated at Watts Bar Unit 1) to 1,700. This is the “steady state” tritium-irradiation program expected in the future to meet “mission requirements.”

A fiscal-year 2010 request of $68 million for “Tritium Readiness” actually represents a slight decline from the $72 million that Congress appropriated for fiscal year 2009. But, according to the National Nuclear Security Administration budget, “plans are being initiated to bring additional production capacity on line using TVA's Sequoyah Unit #1 and #2 reactors to meet tritium production requirements, specified in the Nuclear Weapons Stockpile Plan signed annually by the President.”

From this review, one can conclude that the current U.S. government outlay for tritium was or is to be about $45 M/year. This corresponds reasonably well to the estimated value of tritium produced by all four embodiments of this invention in a 100 MWe small modular reactor, without additionally offsetting the cost by sale of electricity, or without taking credit for sale of fission-product radioactive elements produced in three of the embodiments.

### Lithium Availability

The national and international availability of lithium metal does not seem to be a limiting resource or cost factor.

The United States was the prime producer of lithium between the late 1950s and the mid 1980s. At the end of the Cold War, the stockpile of lithium was roughly 42,000 tons of lithium hydroxide. The lithium stockpile in the U.S. defense program was isotopically depleted by 75%, because lithium-6 enrichment increased tritium production in dedicated nuclear reactors and because enriched lithium increased the explosive yield of nuclear weapons.

Natural lithium has been used in commercial applications to decrease the melting temperature of glass and to improve the melting behavior of aluminum oxide. Lithium oxides are a component in ovenware; worldwide, this is the single largest use for lithium compounds. These applications dominated the market until the mid-1990s. After the end of the nuclear arms race, the demand for lithium decreased and the sale of Department of Energy stockpiles on the open market further reduced prices. The use in lithium ion batteries has increased the demand for lithium and became the dominant use in 2007.

Lithium salts are extracted from mineral springs, brine pools, and brine deposits. Worldwide reserves of lithium are estimated as 13 million tons. The metal is produced electrolytically from a mixture of fused lithium chloride and potassium chloride. In 1998 it was selling for about $95/kg. Lithium is now in high demand because of its role in batteries.

### Cost Optimization

In order to choose between various radioactive-material production-reactor design options as described in this invention, and to compare them with other options elsewhere formulated or implemented, a measure of comparative value is required.

One such common measure is the computed monetary value determined from the sum of statistically weighted functions associated with various attributed qualities.

For this invention, mathematical integration over a 30-year lifespan could be assumed in making a normalized comparison for a reactor that produces radioactive materials which have an assignable commercial value.

The optimized value for the chosen design-embodiment will be comprised of three components, one for the projected value of tritium, a second for expected value of electricity or process heat, and a third for the calculated commercial value of timely fission products. Tradeoffs can be evaluated for the cost of designing a facility to maximize either or both of tritium and fission-product creation.

To be adjusted on the basis of national and international requirements is the value of radioactive fission products for medical and industrial uses. Fission products could be collected in the coolant of a solid-fuel reactor with porous fuel rods or in the coolant that contains reactor fuel immersed in the coolant. Each of these production capabilities, costs, and values can be parameterized in terms of their respective requirements and radioisotope yield.

### Advantages

This LLCR of this invention for producing radioactive materials is designed to enhance the creation of rare radioactive materials that have significant value for national defense, research, medical care, with saleable steam or electricity produced as a byproduct.

Some radioactive materials—such as tritium, plutonium-238, and various radioisotopes derived from nuclear-fission byproducts—are scarce in nature and difficult to produce, yet have important roles—current and future—in advanced national-security applications, ongoing scientific and industrial research, modern medical diagnosis/treatment, and future commercial energy production by fusion-breeder reactors.

This invention is of a lithium-liquid-cooled intermediate-neutron or fast-neutron energy-spectrum fission reactor which has tangible attributes that can be tailored to enhance the production of one or more of these scarce and valuable radioactive materials. Liquid lithium in this invention has a multipurpose role: as a neutronic moderator, as a circulating reactor coolant, and as a medium for transporting radioactive substances to various radioactive-material-extraction devices.

Compared with other nuclear reactors applied or engineered for radioactive-material production, the proposed LLCR disclosed in this invention would provide higher effective production rates (yields) specifically for tritium and for selected fission-product radioisotopes. Also, the LLCR of this invention would have greater production flexibility to meet uncertain and potentially changing national and international requirements in a multi-decade planning horizon.

One problem that surfaced in the molten-salt research experiment concerned the tritium produced by neutron reactions with lithium. At high temperatures the radioactive tritium, which is, of course, chemically like hydrogen, penetrates metals quite readily, and unless captured in some way, would appear in the steam generators and reach the atmosphere. After considerable development work, it was found that the intermediate salt coolant, a mixture of sodium fluoride and sodium fluoroborate, would capture the tritium and that it could be removed and isolated in the gas purge system.

Another attribute intended for this invention is a designed capability such that this specialized lithium-cooled nuclear reactor would be functionally licensable and economically viable, while meeting prioritized goals of national importance.

### Core Designs

There are four important preferred designs of the LLCR core. In each design, radioactive products produced inside the reactor vessel, within or in conjunction with the lithium coolant, would be transported, by a liquid-transport continuously circulating pipage loop, to a designated location outside the reactor vessel where an extraction system is attached to chemically process the continuously recirculating fluid and to where a separate heat-transfer system is located to reduce the temperature of the liquid coolant, thus generating usable or marketable steam, heat, or electricity.

1. The first core design is a nuclear reactor core with traditional cladded solid-fuel elements in the reactor core zone, with the core permeated and cooled by a lithium-based liquid metal, and with the core surrounded by the same coolant circulating in an external neutron moderator and reflector zone inside the reactor containment vessel. In this first embodiment, the primary radioactive material produced is tritium, while radioactive fission products might or might not be recovered after the core fuel elements are removed from the reactor and undergo a deliberate fission-product removal process. The tritium product is recovered from the circulating coolant by continuous on-line separation processes that are accomplished outside the reactor containment vessel.
2. The second core design is a nuclear reactor core with porous solid-fuel elements in the reactor core zone, with the core permeated and cooled by a lithium-based coolant, and with the core surrounded by the same coolant circulating in an external neutron moderator and reflector zone inside the reactor containment vessel. In this second embodiment, tritium is the primary radioactive material produced; however, fission products would also migrate or be expelled continuously from the fuel into the coolant and be transported by said coolant. Both the tritium and the fission products would be separated and recovered from the circulating coolant by continuous on-line processes that are accomplished outside the reactor containment vessel.
3. The third core design is a LLCR in which the fissionable fuel is chemically and physically mixed with the lithium-based liquid coolant, and the circulating mixture is surrounded by external or internal neutron reflectors and moderators at or inside the inside wall of the reactor containment vessel. In this third embodiment, tritium is produced and transported in the coolant; however, fission products would also accumulate and be transported within the circulating fuel-coolant mixture. Both the tritium and the fission products would be recovered from the circulating coolant by continuous on-line separation processes that are accomplished outside the reactor containment vessel.
4. The fourth core design is a variation of each of the previous three embodiments of a liquid-metal cooled nuclear reactor operated in such a way as to remove and recycle the fissionable content of the fuel, whether the reactor is operated with solid or liquid fuel mixtures, whether or not the fissionable fuel is chemically and physically mixed with the lithium-based liquid coolant.

In this fourth core design, tritium, fission products, and reactor fuel are subject to chemical reprocessing so as to recycle the fissile component. The physical plant would be essentially the same as each of the first three embodiments, but with the addition of reactor-core materials chemically removed and reprocessed from either the liquid or solid fuel so as to implement any of the three previous embodiments, with the aim of recovering unconsumed fuel and recycling it for extended operation of the reactor.

Reactor criticality for the fourth core design would be sustained and balanced by reconstituting and replacing the solid or liquid fuel that constitutes the reactor core with the necessary fissile and fertile fuel composition, by such means as to reconstitute and resupply the fuel cycle in a manner the effectively sustains, converts, or breeds new fissile nuclear fuel from fertile nuclear components, such as U-238 or Th-232.

In general, the above four designs of this radioisotope-production invention, are schematically displayed in FIGS. 2 through 5, representing design and construction options to be chosen based on demand, financial, regulatory, engineering, throughput, feasibility, and other considerations.

In summary, this invention is designed to enhance the production of rare radioactive materials that have significant value for national defense, research, medical care, electricity production, and other uses.

What is claimed is:

1. A nuclear plant for the production of electric power and in addition real-time production of large quantities of valuable radioactive fission and activation products, said nuclear plant comprising:
A. a lithium-containing primary coolant that also contains fissile or fertile material arranged so that the primary coolant will accumulate large quantities of tritium and other valuable radioactive products,
B. a chemical processing plant, and
C. a processing loop adapted to flow a portion of the primary coolant in through the processing plant for continuous removable of selected valuable radioactive products.

2. The nuclear plant as in claim 1 wherein the primary coolant comprises a molten salt including lithium and the fissile or fertile material which preferably includes uranium.

3. The nuclear plant as in claim 1 wherein the primary coolant comprises a molten salt including lithium and the fissile or fertile material which preferably includes plutonium.

4. The nuclear plant as in claim 1 wherein the primary coolant comprises a molten salt including lithium and the fissile or fertile material which preferably includes thorium.

5. The nuclear plant as in claim 1 wherein the plant is designed to produce power at rates at least as large as 300 MWth (100 MWe).

6. The nuclear plant as in claim 1 wherein the plant also comprises a secondary molten salt coolant loop in which features are included to minimize any radioactive products in the secondary coolant.

7. The nuclear plant as in claim 6 wherein the plant also comprises a steam turbine and an electric generator.

8. The nuclear plant as in claim 7 wherein the secondary loop provides high-temperature heat to efficiently power the steam generator plant to produce up to at least 100 MW of electrical power.

9. The nuclear plant as in claim 1 wherein products of the plant include the electrical power, tritium, technetium-99, and other valuable radioactive products.

10. The nuclear plant as in claim 1 wherein the core design utilizes porous solid-fuel elements cooled by the lithium-containing primary coolant.

11. The nuclear plant as in claim 1 wherein the core design utilizes fissionable fuel mixed with the lithium-containing primary coolant.

12. The nuclear plant as in claim 1 wherein the core design is based on sustaining reactor criticality by replacing reactor fuel with necessary fissile and fertile fuel in order to breed new fissile fuel from the fertile fuel.
